(19) United States
(12) Patent Application Publication
(10) Pub. No.: US 2024/0095596 A1
(43) Pub. Date: Mar. 21, 2024

(54) INTENTION IDENTIFICATION MODEL TRAINING METHOD AND APPARATUS, AND INTENTION IDENTIFICATION METHOD AND APPARATUS

(71) Applicant: Alipay (Hangzhou) Information Technology Co., Ltd., Hangzhou (CN)

(72) Inventors: Weiqiang WANG, Hangzhou (CN); Haotian WANG, Hangzhou (CN); Xiaofeng WU, Hangzhou (CN)

(21) Appl. No.: 18/467,636

(22) Filed: Sep. 14, 2023

(30) Foreign Application Priority Data
Sep. 19, 2022 (CN) 202211135890.8

(51) Int. Cl. G06N 20/00

(52) U.S. Cl. CPC G06N 20/00

(57) ABSTRACT

Implementations of the present specification describe an intention identification model training method and apparatus, and an intention identification method and apparatus. According to the methods in the implementations, training of a target question can be weakened in the first several rounds of model training, and then an intention identification model obtained in the first several rounds of training can be used to identify intentions corresponding to answers that are to be distinguished. Further, the intention identification model is trained again after labels of these intentions are reset, so that the intention identification model obtained through training can also have a good identification effect on an answer to the target question, thereby improving accuracy of intention identification.

### TECHNICAL FIELD

One or more implementations of the present specification relate to the field of artificial intelligence, and in particular, to an intention identification model training method and apparatus, and an intention identification method and apparatus.

### BACKGROUND

In a human-computer interaction system, there are a large amount of question-answer intention identification (also referred to as intention recognition, intent recognition, or intent detection). For example, in a risk control scenario, a user is asked about a current transaction objective or transfer object, and intention of the user is identified based on an answer of the user to the question to determine a current risk status of the user, and to perform corresponding management and control.

However, in some cases, an answer needs to be combined with a question to determine a user intention. For example, for a question “are you playing a general online game or a recharge or money-earning game”, if a user answers “general”, it is clearly impossible to obtain an intention “objective-game” of the user without combining with the question. Therefore, if a model is directly trained by using “general” and “objective-game”, when such answers are used to some new questions, the model identifies all the answers as having the intention “objective-game,” resulting in an error in an identification result.

### SUMMARY

One or more implementations of the present specification describe an intention identification model training method and apparatus, and an intention identification method and apparatus, which improves accuracy of intention identification.

According to an aspect, an intention identification model training method is provided, including: obtaining sample training data used to perform model training, where the sample training data includes sets of questions and answers that are used as sample input data and sample intentions that are used as sample output data, the questions include a target question, and the target question satisfies a following: an intention corresponding to an answer to the target question is a same as an intention corresponding to an answer to another question; weakening training of the target question in the first N rounds of model training in performing M rounds of model training by using the sample training data, so that a probability that an intention identification model obtained in the first N rounds of training identifies an intention corresponding to an answer to the target question is less than a first predetermined threshold, where both M and N are positive integers, and N<M; performing intention identification on the sample input data by using the intention identification model obtained in the first N rounds of model training to obtain at least one first intention; resetting a label of each first intention of the at least one first intention based on a label of a sample intention; and continuing to train the intention identification model by using the sample training data obtained after the label of the first intention has been reset.

In some implementations, the sample training data includes first sample training data, and questions in the first sample training data do not include the target question; and the weakening the training of the target question in the first N rounds of model training includes: training the intention identification model in the first N rounds of model training by using the first sample training data.

In some implementation, the performing the intention identification on the sample input data by using the intention identification model obtained in the first N rounds of model training to obtain the at least one first intention includes: inputting the sample input data to the intention identification model obtained in the first N rounds of model training, to output probability values of sample intentions; determining, from the sample intentions, a target intention corresponding to each piece of sample input data that is input to the intention identification model, where the target intention is used to represent a real intention of an answer in the sample input data; determining a probability value of the target intention from the probability values of the sample intentions; and determining, among the target intentions, a target intention having a probability value less than a second predetermined threshold as the first intention.

In some implementations, a label of the target intention is a first label, and a label of an intention that is not the target intention in the sample intentions is a second label; and the resetting the label of each first intention based on the label of the sample intention includes: resetting the label of the first intention to be the second label.

In some implementations, a label of the target intention is a first label, and a label of an intention that is not the target intention in the sample intentions is a second label; the resetting the label of each first intention based on the label of the sample intention includes: copying the sample intentions in the sample training data to obtain extended intentions, where each extended intention uniquely corresponds to one sample intention; resetting a label of a sample intention corresponding to the first intention to be the second label; and resetting a label of an extended intention corresponding to the first intention to be the first label; and where the continuing to train the intention identification model by using the sample training data obtained after the label of the first intention has been reset includes: continuing to train the intention identification model by using, as the sample output data, the sample intentions and the extended intentions obtained after the label of the first intention has been reset.

According to an aspect, an intention identification method is provided, including: obtaining to-be-identified data on which intention identification is to be performed; and performing intention identification on the to-be-identified data by using an intention identification model to obtain an intention identification result, where the intention identification model is obtained through training by using any intention identification model training method according to the first aspect.

In some implementation, the to-be-identified data includes a to-be-identified set of a question and an answer; and the performing the intention identification on the to-be-identified data by using the intention identification model to obtain the intention identification result includes: inputting the to-be-identified data to the intention identification model to obtain a preliminary intention identification result output by the intention identification model; in response to that the preliminary intention identification result is an extended intention, inputting the answer in the to-be-identified set to a pre-trained question prediction model to obtain a predicted question, where the extended intention is used to represent an intention obtained by copying a sample intention for training the intention identification model, the question prediction model is obtained by training at least one sample set, and each sample set includes one question and one answer; determining whether the question in the to-be-identified set is consistent with the predicted question;
in response to that the question in the to-be-identified set is consistent with the predicted question, determining that the intention identification result of the to-be-identified data is the preliminary intention identification result; and
in response to that the question in the to-be-identified set is inconsistent with the predicted question, determining that the intention identification result of the to-be-identified data is not the preliminary intention identification result.

According to an aspect, an intention identification model training apparatus is provided, including a training data acquisition module, a first training module, an intention identification module, a label resetting module, and a second training module.

The training data acquisition module is configured to obtain sample training data used to perform model training, where the sample training data includes sets of questions and answers that are used as sample input data and sample intentions that are used as sample output data, the questions include a target question, and the target question satisfies a following: an intention corresponding to an answer to the target question is a same as an intention corresponding to an answer to another question.

The first training module is configured to weaken training of the target question in the first N rounds of model training in performing M rounds of model training by using the sample training data obtained by the training data acquisition module, so that a probability that an intention identification model obtained in the first N rounds of training identifies an intention corresponding to an answer to the target question is less than a first predetermined threshold, where both M and N are positive integers, and N<M.

The intention identification module is configured to perform intention identification on the sample input data by using the intention identification model obtained by the first training module through training in the first N rounds of model training to obtain at least one first intention.

The label resetting module is configured to reset, based on a label of a sample intention, a label of each first intention of the at least one first intention obtained by the intention identification module.

The second training module is configured to continue to train the intention identification model by using the sample training data obtained after the label resetting module has reset the label of the first intention.

According to an aspect, an intention identification apparatus is provided, including an identification data acquisition module and an identification result determining module.

The identification data acquisition module is configured to obtain to-be-identified data on which intention identification is to be performed.

The identification result determining module is configured to perform, by using an intention identification model, intention identification on the to-be-identified data obtained by the identification data acquisition module, to obtain an intention identification result, where the intention identification model is obtained through training by using the intention identification model training apparatus according to the third aspect.

According to an aspect, a computing device is provided, including a memory and a processor, where the memory stores executable code, and when executing the executable code, the processor implements the method according to any one of the first aspect and the second aspect.

According to the methods and the apparatuses provided in the implementations of the present specification, when the intention identification model is trained, training of the target question is first weakened in the first several rounds of model training, to ensure that when identifying an answer to the target question, the model obtained in the first several rounds of training can have a small probability of identifying an intention corresponding to the answer. Further, the sample input data in the sample training data is identified by using the model obtained in the first several rounds of training to obtain the first intention. Then, the label of the obtained first intention is reset, and the intention identification model continues to be trained by using the sample training data obtained after the label is reset. It can be learned that in this solution, training of the target question is weakened in the first several rounds of training, so that some intentions are identified to be distinguished. Then, the intention identification model is trained again after labels of these intentions are reset, so that the intention identification model obtained through training can also have a good identification effect on an answer to the target question, thereby improving accuracy of intention identification.

### BRIEF DESCRIPTION OF DRAWINGS

To describe the technical solutions in the implementations of the present specification or in the existing technologies more clearly, the following is a brief introduction of the accompanying drawings for illustrating such technical solutions. Clearly, the accompanying drawings described below are some implementations of the present specification, and a person of ordinary skill in the art can derive other drawings from such accompanying drawings without making innovative efforts.

FIG. 1 is a flowchart illustrating an intention identification model training method according to an implementation of the present specification;

FIG. 2 is a flowchart illustrating a method for determining a first intention according to an implementation of the present specification;

FIG. 3 is a flowchart illustrating a label resetting method according to an implementation of the present specification;

FIG. 4 is a flowchart illustrating an intention identification method according to an implementation of the present specification;

FIG. 5 is a flowchart illustrating another intention identification method according to an implementation of the present specification;

FIG. 6 is a schematic diagram illustrating an intention identification model training apparatus according to an implementation of the present specification; and

FIG. 7 is a schematic diagram illustrating an intention identification apparatus according to an implementation of the present specification.

### DESCRIPTION OF EMBODIMENTS

For an intention identification algorithm or model, a user's answer is usually directly input to the model for recognizing an intention. However, when samples are insufficient, the model easily tends to focus only on an answer, resulting in an error in intention identification.

For example, for the example question “are you playing a general online game or a recharge or money-earning game”, when there is a small amount of sample data, during model training, the answer “general” is likely to be bound to the intention “objective-game” of the question, that is, the answer “general” appears only under answers to this question. Therefore, when the model performs identification, when an input is “general”, the model identifies the intention as “objective-game”. However, if a new question “what kind of product are you buying?” appears, and a user answers “just a general product”, because in samples for model training, the answer “general” appears only under the question “are you playing a general online game or a recharge or money-earning game”, in this case, the model also identifies an intention of “just a general product” as “objective-game”. Clearly, in this case, an actual intention should be “type-product” instead of “objective-game”. This causes an error in an intention identification result, and further causes an error in subsequent human-computer interaction.

Based on this, in the solutions of this specification, training of a target question is weakened to identify answer samples that are to be distinguished, and then labels of intentions corresponding to these answers are reset, so that a model finally obtained through training can also have a good accuracy in identifying an answer to the target question.

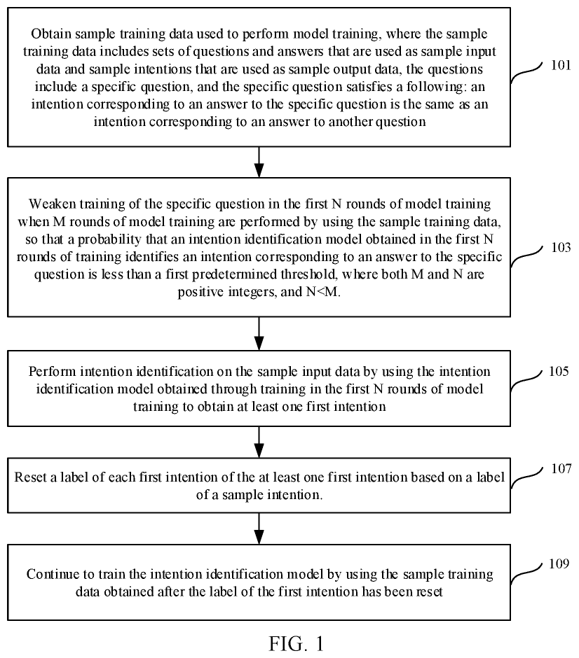

As shown in FIG. 1, an example implementation of the present specification provides an intention identification model training method. The method can include the following steps.

Step 101: Obtain sample training data used to perform model training, where the sample training data includes sets of questions and answers that are used as sample input data and corresponding sample intentions that are used as sample output data, the questions include a target question, and the target question satisfies the following: an intention corresponding to an answer to the target question is a same as an intention corresponding to an answer to another question.

Step 103: Weaken the training of the target question in the first N rounds of model training when M rounds of model training are performed by using the sample training data, so that a probability that an intention identification model obtained in the first N rounds of training identifies an intention corresponding to an answer to the target question is less than a first determined threshold, where both M and N are positive integers, and N<M. A determined threshold can be predetermined or dynamically determined in a training process. A determined threshold may be dynamically adjusted in a training process based on training results or in a validation process of the trained model. In the description herein, a predetermined first threshold is used as a illustrative example, which does not limit the scope of the specification.

Step 105: Perform intention identification on the sample input data by using the intention identification model obtained through training in the first N rounds of model training to obtain at least one first intention.

Step 107: Reset a label of each first intention of the at least one first intention based on a label of a sample intention.

Step 109: Continue to train the intention identification model by using the sample training data obtained after the labels of the at least one first intention have been reset.

In some implementations, when the intention identification model is trained, training of the target question is first weakened in the first several or N rounds of model training, to ensure that when identifying an answer to the target question, the model obtained in the first several or N rounds of training can have a small probability of identifying an intention corresponding to the answer. Further, the sample input data in the sample training data is identified by using the model obtained in the first several rounds of training to obtain the first intention. Then, the label of the obtained first intention is reset, and the intention identification model continues to be trained by using the sample training data obtained after the label has been reset. It can be appreciated that in this solution, training of the target question is weakened in the first several or N rounds of training, and the intentions obtained by such a trained model can be detected and labels of the identified intentions can be reset. Then, the intention identification model is trained again after labels of these detected intentions are reset, so that the intention identification model obtained through training can also have a good identification effect on an answer to the target question, thereby improving accuracy of intention identification.

The following describes the steps in FIG. 1 with reference to example implementations.

First, in step 101, the sample training data used to perform model training is obtained.

In this step, the sample training data can include the set of questions and answers that are used as the sample input data, and the sample intention that is used as the sample output data. For example, the question in the sample input data can be “do you usually use manner A or manner B for transaction?”, and an answer corresponding to the question can be “manner A”, “manner B”, “manner A and manner B”, etc. In this case, one question and one answer can form one piece of sample input data. A sample intention corresponding to sample input data formed by any one of the above-mentioned groups of questions and answers can be “type-transaction”, “objective-manner”, “object-transaction”, etc.

In addition, in some example application scenarios, intentions of some target questions can be obtained based on both questions and answers, and intentions corresponding to answers to the target questions are a same as intentions corresponding to answers to other questions. In other words, when an answer to a target question also appears as an answer under another question, it can be considered that the another question has an intention same as the target question. For example, for a question “are you playing a general online game or a money-earning game?”, one of answers to this question is “general”. For a question “What do you buy”, the answer “general” can also appear under the question. Although the two answers are the same, actual intentions of the answers to different questions are different. However, in practice, if question information is not considered or the question information is weakened, it is likely to consider that there is a same intention when the answer is under different questions. Therefore, before the sample training data used to perform model training is obtained, experience can be first used to define target questions. Then, the target questions and corresponding answers and intentions are used as a part forming the sample training data.

In addition, in some cases of the questions and the answers, only the answer corresponding to the question needs to be known to learn an intention corresponding to the answer. For example, for a question “What do you eat?”, an answer is “snack”. In this case, it is very easy to learn an intention “food-snack” of this type of question and answer. Therefore, in some implementations, the sample training data can further include an answer used as the sample input data and a sample intention used as the sample output data.

Then, in step 103, training of the target question is weakened in the first N rounds of model training when the M rounds of model training are performed by using the sample training data, so that the probability that the intention identification model obtained in the first N rounds of training identifies the intention corresponding to the answer to the target question is less than the first predetermined threshold, where both M and N are positive integers, and N<M.

In this step, when model training is performed, training of the target question is first weakened. As such, when a model trained after the target question is weakened is used to identify the sample training data, it is difficult for the model to identify the intention of the answer to the target question, so that answers to the target question that are to be decoupled can be identified, that is, the answers will be distinguished from the answer to another question.

Before model training is performed, some answers to the target question are identified to be combined with the question. For example, for a question “are you playing a general online game or a recharge or money-earning game”, two answers A “general” and B “online game” have a same intention “objective-game”, but answer A is identified to be combined with the question to identify the intention, and B can directly identify the intention. Therefore, first, of the to-be-combined answer to the target question is identified. Then, in the M rounds of model training, training of the target question and of the to-be-combined answer is weakened in the first several or N rounds of training, so that a probability that an intention identification model obtained in the first several or N rounds of training identifies an actual intention corresponding to the answer to the target question is less than a first determined threshold.

For example, in some implementations, the sample training data used for model training meets the following: an amount of sample data that includes the target question is far less than an amount of sample data that does not include the target question. For example, a ratio between the amounts of the two types of sample data can be 1:1000, 1:10000, etc. For example, the first predetermined threshold can be set to 1%, and a ratio of the sample data that includes the target question to the sample data that does not include the target question can be adjusted, so that when the obtained model performs intention identification on the sample training data, a probability that the model identifies the intention corresponding to the answer to the target question is less than 1%.

For an example, in an implementation, the sample data of the target question may not be trained. For example, in step 103, when training of the target question is weakened in the first N rounds of model training, the intention identification model can be trained by using first sample training data in the first N rounds of model training. The first sample training data is sample training data that does not include the target question. As such, because the target question and the answer of the target question are not used for training, the model obtained in the first N rounds cannot identify the intention corresponding to the answer to the target question, so that answers that are to be distinguished and decoupled can be more accurately identified from identification results.

Then, in step 105, intention identification is performed on the sample input data by using the intention identification model obtained in the first N rounds of model training to obtain the at least one first intention.

In this step, the sample input data for intention identification may include sample data having the target question. Because training of the target question is weakened in the first N rounds of model training in step 103, the intention identification model obtained in this case cannot identify the intention corresponding to the answer to the target question. As such, answers that are to be distinguished or decoupled can be determined based on a real intention under the target question and an identification result of the intention identification model, to determine intentions corresponding to the answers.

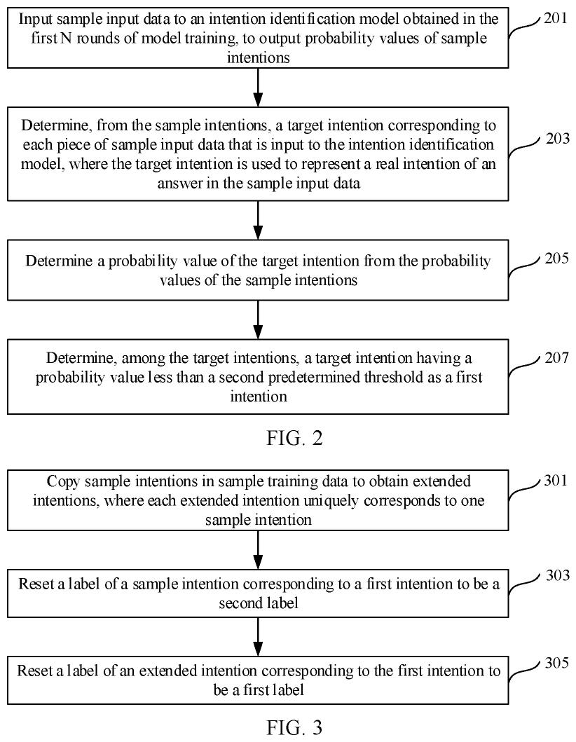

As shown in FIG. 2, in some implementations, step 105 can be implemented by using the following steps when the sample input data is identified by using the intention identification model obtained in the first N rounds of model training to obtain the at least one first intention.

Step 201: Input the sample input data to the intention identification model obtained in the first N rounds of model training, to output probability values of sample intentions.

Step 203: Determine, from the sample intentions, a target intention corresponding to each piece of sample input data that is input to the intention identification model, where the target intention is used to represent a real intention of an answer in the sample input data.

Step 205: Determine a probability value of the target intention from the probability values of the sample intentions.

Step 207: Determine, among the target intentions, a target intention having a probability value less than a second predetermined threshold as the first intention.

In some implementations, the first intention is an intention that is obtained by combining the answer to the target question with the target question. When the first intention is determined, first, the sample input data is input to the intention identification model obtained through training in the first N rounds of model training to obtain the probability values of the sample intentions. Then, the target intention corresponding to each piece of sample input data that is input to each intention identification model is determined from the sample intentions, and the probability value of the target intention is further determined from the probability values of the sample intentions. Finally, among the target intentions, the target intention having a probability value less than the second predetermined threshold can be determined as the first intention. Because training of the target question is weakened in the first N rounds of model training, when the intention identification model obtained through training in the first N rounds of model training is used to perform intention identification on the sample input data, if a certain intention is an intention that an answer really has and the intention is not identified, or a probability value of the identified intention is very low, it indicates that the intention is the first intention, that is, intentions corresponding to answers that are to be decoupled.

The following describes step 201.

The sample intentions are intentions corresponding to the set of questions and answers in the sample training data, for example, “type-transaction”, “objective-manner”, “object-transaction”, or “objective-game”. After the sample input data is input to the intention identification model, probabilities corresponding to the sample intentions can be obtained. For example, for an answer “buy a puppy” to a question “what do you buy”, an intention corresponding to the answer is “objective-buy a pet”. In this case, when the question and the answer are input to the intention identification model, an identified intention is “objective-buy a pet”, e.g., a probability value of the intention “objective-buy a pet” is relatively high, and a probability value of another intention is relatively low.

The following describes step 203.

An answer to any question has at least one target intention, e.g., a real intention of the question and the answer. For example, for a target question “are you playing a general online game or a recharge or money-earning game?”, answer A to the question is “general”. A target intention corresponding to the question and the answer is “objective-game”, assuming that a real intention of the question and the answer is “objective-game”. Other intentions in the sample intentions are not real intentions for the question and the answer.

An answer to a question can have a plurality of intentions. If an answer to a question “what are you transferring money to account A for?” is “buy a puppy”, real intentions corresponding to the answer may be “objective-buy a pet” and “account-transfer object”.

The following describes step 205.

In step 205, when the probability values of the sample intentions and the target intention are determined, the probability value corresponding to the target intention can be further determined. For example, the probability value of the target intention determined in step 203 is determined from the probability values of the sample intentions determined in step 201. For example, for the answer “general” to the question “are you playing a general online game or a recharge or money-earning game?”, a probability value of the target intention “objective-game” is determined. For another example, for the answer “buy a puppy” to the question “what are you transferring money to account A for?”, respective probability values of the target intentions “objective-buy a pet” and “account-transfer object” are determined.

The following describes step 207.

In step 207, when the model obtained in the first N rounds of training is used to identify intention on the questions and answers, although “objective-game” is a real intention corresponding to the answer “general”, because training of the target question is weakened, in an obtained identification result, a probability value of the intention “objective-game” is small. Based on this, after the probability value of the target intention is determined, whether the target intention is the first intention can be determined based on the probability value. For example, the second predetermined threshold is 50%, and the probability value of the intention of “objective-game” is less than 50%. As such, a target intention having a probability value less than 50% is determined as the first intention, among the target intentions.

Further, in step 107, the label of each first intention is reset based on the label of the sample intention.

In this step, after first intentions corresponding to answers that are to be decoupled or distinguished have been determined, the first intentions are distinguished by resetting a label of each first intention. As such, when intention identification is performed by using the intention identification model finally obtained through training, an intention corresponding to a target question and an answer of the target question can be more accurately identified.

In some example implementations, a label of a target intention is a first label, and a label of an intention that is not the target intention in the sample intentions is a second label. For example, the first label is 1, and the second label is 0. For example, when the label of each first intention is reset based on the label of the sample intention, the label of the first intention is reset to be the second label. The second label is different from the label of the target intention. Therefore, the label of the first intention is reset to be the second label, so that the intention identification model cannot identify the intention by an answer to the target question, but can identify the intention by using another answer. For example, in some implementations, the intention identification model cannot identify the intention “objective-game” by using the answer “general”, but can identify the intention “objective-game” by using the answer “online game”, thereby improving accuracy of intention identification.

In some implementations, the label of the first intention can also be reset by extending an intention. For example, as shown in FIG. 3, when a label of the target intention is a first label, and a label of an intention that is not the target intention in the sample intentions is a second label, step 107 can be implemented by using the following steps when the label of the first intention is reset.

Step 301: Copy the sample intentions in the sample training data to obtain extended intentions, where each extended intention uniquely corresponds to a sample intention.

Step 303: Reset a label of a sample intention corresponding to the first intention to be the second label.

Step 305: Reset a label of an extended intention corresponding to the first intention to be the first label.

In this implementation, when the label of the first intention is reset, the sample intentions in the sample training data can be first copied to obtain extended intentions that are in a one-to-one correspondence with the sample intentions. Then, the label of the sample intention corresponding to the first intention is reset to be the second label, and the extended label corresponding to the first intention is reset to be the first label. As such, when the first intention is identified, whether the first intention corresponds to the sample intention or the extended intention can be determined to further determine whether the intention is an intention corresponding to an answer to a target question, thereby improving accuracy of identifying the intention of the answer to the target question.

Finally, in step 109, the intention identification model continues to be trained by using the sample training data obtained after the label of the first intention has been reset.

After the label of the first intention is reset, model training can continue to be performed by using the data obtained after the label is reset. For example, after the label of the sample intention corresponding to the first intention is reset to be the second label and the label of the extended intention corresponding to the first intention is reset to be the first label, in step 109, the intention identification model can continue to be trained by using, as the sample output data, the sample intention and the extended intention obtained after the label of the first intention has been reset, so as to improve accuracy of an intention of an answer to a target question.

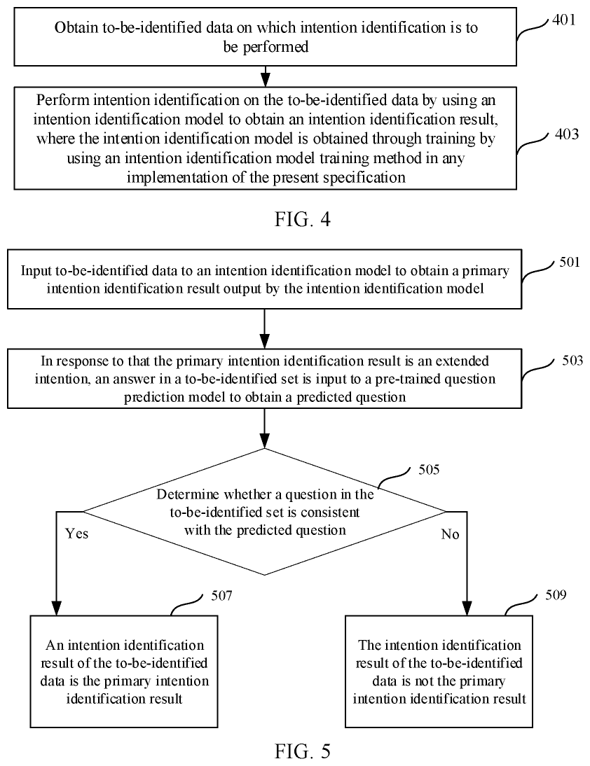

As shown in FIG. 4, an implementation of the present specification further provides an intention identification method. The method can include the following steps.

Step 401: Obtain to-be-identified data on which intention identification is to be performed.

Step 403: Perform intention identification on the to-be-identified data by using an intention identification model to obtain an intention identification result, where the intention identification model is obtained through training by using the intention identification model training method in any implementation of the present specification.

Because training of a target question is weakened in the first several rounds of model training, some intentions are identified to be distinguished. Further, the intention identification model is trained again after labels of these identified intentions are reset. Therefore, the intention identification model can also have a good identification effect on an answer to the target question, that is, have a high accuracy during intention identification.

In some implementations, the to-be-identified data can include a to-be-identified set of a question and an answer. As such, as shown in FIG. 5, step 403 can be implemented by using the following steps when the to-be-identified data is identified by using the intention identification model to obtain the intention identification result.

Step 501: Input the to-be-identified data to the intention identification model to obtain a preliminary intention identification result output by the intention identification model.

Step 503: In response to that the preliminary intention identification result is an extended intention, input the answer in the to-be-identified set to a pre-trained question prediction model to obtain a predicted question, where the extended intention is used to represent an intention obtained by copying a sample intention for training the intention identification model, the question prediction model is obtained by training at least one sample set, and each sample set includes one question and one answer.

Step 505: Determine whether the question in the to-be-identified set is consistent with the predicted question.

Step 507: In response to that the question in the to-be-identified set is consistent with the predicted question, determine that the preliminary intention identification result is the intention identification result of the to-be-identified data.

Step 509: In response to that the question in the to-be-identified set is inconsistent with the predicted question, determine that the intention identification result of the to-be-identified data is not the preliminary intention identification result.

In this implementation, when the to-be-identified data is identified to obtain the intention identification result, first, the to-be-identified data can be input to the intention identification model to obtain the output preliminary intention identification result. Then, in response to that the preliminary intention identification result is an extended intention, the answer in the to-be-identified set is input to the pre-trained question prediction model to predict a predicted question corresponding to the answer. Further, whether an actual question in the to-be-identified set is consistent with the predicted question is further determined. If the actual question is consistent with the predicted question, it indicates that the preliminary intention identification result is an intention of the to-be-identified data; and if the actual question is inconsistent with the predicted question, it indicates that the preliminary intention identification result is not the intention of the to-be-identified data.

Because there may be more than one target questions, after the extended intention is predicted, it is determined whether the question in the current to-be-identified data corresponds to a certain target question. Because the answer in the current to-be-identified data appears only under the target question corresponding to the answer, the question can be directly predicted based on the answer. If the question predicted based on the answer does not match the current question, it indicates that the question in the current to-be-identified data does not correspond to the certain target question. Therefore, a prediction result needs to be deleted, that is, a result identified by the intention identification model is not adopted.

For example, for a target question “are you playing a general online game or a recharge or money-earning game?”, an answer “general” appears only under the target question. Therefore, the question can be predicted when the answer “general” is input to the question prediction model. However, if an actually predicted question is not the target question, it indicates that a result predicted by the intention identification model is unreliable, and therefore the result of the intention identification model is not adopted.

It should be noted that, the question prediction model is obtained by training sample data that includes a question and an answer. The question prediction model can be a model independent of the intention identification model, or can be integrated into the intention identification model, and the intention identification model also predicts a question.

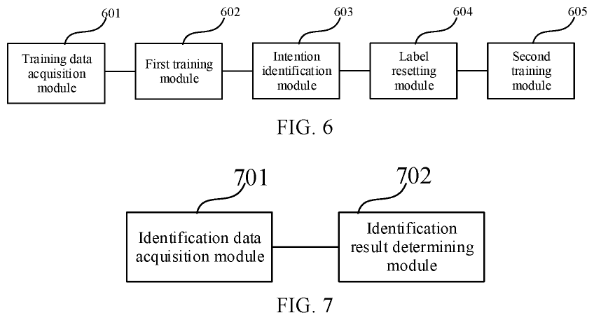

As shown in FIG. 6, an implementation of the present specification further provides an intention identification model training apparatus, including a training data acquisition module 601, a first training module 602, an intention identification module 603, a label resetting module 604, and a second training module 605.

The training data acquisition module 601 is configured to obtain sample training data used to perform model training, where the sample training data includes sets of questions and answers that are used as sample input data and sample intentions that are used as sample output data, the questions include a target question, and the target question satisfies a following: an intention corresponding to an answer to the target question is a same as an intention corresponding to an answer to another question.

The first training module 602 is configured to weaken training of the target question in the first N rounds of model training in performing M rounds of model training by using the sample training data obtained by the training data acquisition module 601, so that a probability that an intention identification model obtained in the first N rounds of training identifies an intention corresponding to an answer to the target question is less than a first preset threshold, where both M and N are positive integers, and N<M.

The intention identification module 603 is configured to perform intention identification on the sample input data by using the intention identification model obtained by the first training module 602 through training in the first N rounds of model training to obtain at least one first intention.

The label resetting module 604 is configured to reset, based on a label of a sample intention, a label of each first intention of the at least one first intention obtained by the intention identification module 603.

The second training module 605 is configured to continue to train the intention identification model by using the sample training data obtained after the label resetting module 604 has reset the label of the first intention.

In some implementations, the sample training data includes first sample training data, and questions in the first sample training data do not include the target question.

When weakening the training of the target question in the first N rounds of model training, the first training module 602 is configured to train the intention identification model by using the first sample training data in the first N rounds of model training.

In some implementations, when performing the intention identification on the sample input data by using the intention identification model obtained in the first N rounds of model training to obtain the at least one first intention, the intention identification module 603 is configured to perform the following operations: inputting the sample input data to the intention identification model obtained in the first N rounds of model training, to output probability values of sample intentions; determining, from the sample intentions, a target intention corresponding to each piece of sample input data that is input to the intention identification model, where the target intention is used to represent a real intention of an answer in the sample input data; determining a probability value of the target intention from the probability values of the sample intentions; and determining, among the target intentions, a target intention having a probability is less than a second predetermined threshold as the first intention.

In some implementations, a label of the target intention is a first label, and a label of an intention that is not the target intention in the sample intentions is a second label.

When resetting the label of each first intention of the at least one first intention based on the label of the sample intention, the label resetting module 604 is configured to reset the label of the first intention to be the second label.

In some implementations, a label of the target intention is a first label, and a label of an intention that is not the target intention in the sample intentions is a second label.

When resetting the label of each first intention of the at least one first intention based on the label of the sample intention, the label resetting module 604 is configured to perform the following operations: copying the sample intentions in the sample training data to obtain extended intentions, where each extended intention uniquely corresponds to one sample intention; resetting a label of a sample intention corresponding to the first intention to be the second label; and resetting a label of an extended intention corresponding to the first intention to be the first label.

In some implementations, when continuing to train the intention identification model by using the sample training data obtained after the label of the first intention has been reset, the second training module 605 is configured to continue to train the intention identification model by using, as the sample output data, the sample intentions and the extended intentions obtained after the label of the first intention has been reset.

As shown in FIG. 7, an implementation of the present specification further provides an intention identification apparatus, including an identification data acquisition module 701 and an identification result determining module 702.

The identification data acquisition module 701 is configured to obtain to-be-identified data on which intention identification is to be performed.

The identification result determining module 702 is configured to perform, by using an intention identification model, intention identification on the to-be-identified data obtained by the identification data acquisition module 701, to obtain an intention identification result, where the intention identification model is obtained through training by using the intention identification model training apparatus provided in any one of the above-mentioned implementations.

In some implementations, the to-be-identified data includes a to-be-identified set of a question and an answer.

When performing the intention identification on the to-be-identified data by using the intention identification model to obtain the intention identification result, the identification result determining module 702 is configured to perform the following operations: inputting the to-be-identified data to the intention identification model to obtain a preliminary intention identification result output by the intention identification model; in response to that the preliminary intention identification result is an extended intention, inputting the answer in the to-be-identified set to a pre-trained question prediction model to obtain a predicted question, where the extended intention is used to represent an intention obtained by copying a sample intention for training the intention identification model, the question prediction model is obtained by training at least one sample set, and each sample set includes one question and one answer; determining whether the question in the to-be-identified set is consistent with the predicted question;
in response to that the question in the to-be-identified set is consistent with the predicted question, determining that the intention identification result of the to-be-identified data is the preliminary intention identification result; and
in response to that the question in the to-be-identified set is inconsistent with the predicted question, determining that the intention identification result of the to-be-identified data is not the preliminary intention identification result.

The present specification further provides a computer-readable storage medium. The computer-readable storage medium stores a computer program, and when the computer program is executed in a computer, the computer is enabled to perform the method in any implementation of the present specification.

The present specification further provides a computing device, including a memory and a processor. The memory stores executable code, and when executing the executable code, the processor implements the method in any implementation of the present specification.

It can be understood that the structures shown in the implementations of the present specification do not constitute a specific limitation on the intention identification model training apparatus and the intention identification apparatus. In some other implementations of the present specification, the intention identification model training apparatus and the intention identification apparatus each can include more or fewer components than those shown in the figure, or combine some components, or split some components, or have different component arrangements. The components shown in the figure can be implemented by hardware, software, or a combination of software and hardware.

Content such as information exchange and execution processes between units in the above-mentioned apparatus is based on a same concept as that in the method implementations of the present specification. For specific content, references can be made to the descriptions in the method implementations of the present specification. Details are omitted herein for simplicity.

A person skilled in the art should be aware that in the above-mentioned one or more examples, functions described in the present specification can be implemented by hardware, software, firmware, or any combination thereof. When software is used for implementation, these functions can be stored in a computer-readable medium or transmitted as one or more instructions or codes on the computer-readable medium.

The objectives, technical solutions, and beneficial effects of the present specification are further described in detail in the above-mentioned specific implementations. It should be understood that the above-mentioned descriptions are merely specific implementations of the present application, but are not intended to limit the protection scope of the present application. Any modification, equivalent replacement, or improvement made based on the technical solutions of the present application shall fall within the protection scope of the present application.

What is claimed is:

1. An intention identification model training method, comprising:
obtaining sample training data, the sample training data including sets of questions and answers configured to be sample input data and sample intentions configured to be sample output data, the questions including a target question, and the target question satisfying that an intention corresponding to an answer to the target question is a same as an intention corresponding to an answer to another question;
weakening training of an intention identification model with respect to the target question in first N rounds of model training in performing M rounds of model training by using the sample training data, so that a probability that the intention identification model obtained through the first N rounds of training identifies an intention corresponding to an answer to the target question is less than a first threshold, both M and N being positive integers, and N<M;
performing intention identification on the sample input data by using the intention identification model obtained through the first N rounds of model training to obtain at least one first intention;
resetting a label of each first intention of the at least one first intention based on a label of a sample intention to obtain reset sample training data; and
continuing to train the intention identification model by using the reset sample training data after the label of the first intention has been reset.

2. The method according to claim 1, wherein the sample training data includes first sample training data, and questions in the first sample training data do not include the target question; and
the weakening the training of the intention identification model with respect to the target question in the first N rounds of model training includes:
training the intention identification model in the first N rounds of model training by using the first sample training data.

3. The method according to claim 1, wherein the performing the intention identification on the sample input data by using the intention identification model obtained through the first N rounds of model training to obtain the at least one first intention includes:
inputting the sample input data to the intention identification model obtained through the first N rounds of model training, to output probability values of sample intentions;
determining, from the sample intentions, a target intention corresponding to each piece of sample input data that is input to the intention identification model, wherein the target intention is used to represent a real intention of an answer in the sample input data;
determining a probability value of each target intention from the probability values of the sample intentions; and
determining, among target intentions, a target intention having a probability value less than a second threshold as the first intention.

4. The method according to claim 3, wherein a label of a target intention is a first label, and a label of an intention that is not the target intention in the sample intentions is a second label; and
the resetting the label of each first intention of the at least one first intention based on the label of the sample intention includes:
resetting the label of each first intention to be the second label.

5. The method according to claim 3, wherein a label of a target intention is a first label, and a label of an intention that is not the target intention in the sample intentions is a second label;
the resetting the label of each first intention of the at least one first intention based on the label of the sample intention includes:
copying sample intentions in the sample training data to obtain extended intentions, wherein each extended intention corresponds to a sample intention;
resetting a label of a sample intention corresponding to the first intention to be the second label; and
resetting a label of an extended intention corresponding to the first intention to be the first label; and
wherein the continuing to train the intention identification model by using the reset sample training data after the label of the first intention has been reset includes:
continuing to train the intention identification model by using, as the sample output data, the sample intentions and the extended intentions obtained after the label of the first intention has been reset.

6. The method of claim 1, comprising:
performing intention identification on to-be-identified data by using an intention identification model trained through the M rounds of model training to obtain an intention identification result.

7. The method according to claim 6, wherein the to-be-identified data includes a to-be-identified set of a question and an answer; and
the performing the intention identification on the to-be-identified data by using the intention identification model trained through the M rounds of model training to obtain the intention identification result includes:
inputting the to-be-identified data to the intention identification model trained through the M rounds of model training to obtain a preliminary intention identification result output by the intention identification model;
in response to that the preliminary intention identification result is an extended intention, inputting the answer in the to-be-identified set to a pre-trained question prediction model to obtain a predicted question, wherein the question prediction model is obtained by training at least one sample set, and each sample set includes one question and one answer;
determining whether the question in the to-be-identified set is consistent with the predicted question;
in response to that the question in the to-be-identified set is consistent with the predicted question, determining that the preliminary intention identification result is an intention identification result of the to-be-identified data; and
in response to that the question in the to-be-identified set is inconsistent with the predicted question, determining that the preliminary intention identification result is not an intention identification result of the to-be-identified data.

8. A computing system including one or more processors and one or more storage devices, the one or more storage devices individually or collectively storing computer executable instructions, which when executed by the one or more processors, enable the one or more processors to, individually or collectively, perform acts comprising:
obtaining sample training data, the sample training data including sets of questions and answers configured to be sample input data and sample intentions configured to be sample output data, the questions including a target question, and the target question satisfying that an intention corresponding to an answer to the target question is a same as an intention corresponding to an answer to another question;
weakening training of an intention identification model with respect to the target question in first N rounds of model training in performing M rounds of model training by using the sample training data, so that a probability that the intention identification model obtained through the first N rounds of training identifies an intention corresponding to an answer to the target question is less than a first threshold, both M and N being positive integers, and N<M;
performing intention identification on the sample input data by using the intention identification model obtained through the first N rounds of model training to obtain at least one first intention;
resetting a label of each first intention of the at least one first intention based on a label of a sample intention to obtain reset sample training data; and
continuing to train the intention identification model by using the reset sample training data after the label of the first intention has been reset.

9. The computing system according to claim 8, wherein the sample training data includes first sample training data, and questions in the first sample training data do not include the target question; and
the weakening the training of the intention identification model with respect to the target question in the first N rounds of model training includes:
training the intention identification model in the first N rounds of model training by using the first sample training data.

10. The computing system according to claim 8, wherein the performing the intention identification on the sample input data by using the intention identification model obtained through the first N rounds of model training to obtain the at least one first intention includes:
inputting the sample input data to the intention identification model obtained through the first N rounds of model training, to output probability values of sample intentions;
determining, from the sample intentions, a target intention corresponding to each piece of sample input data that is input to the intention identification model, wherein the target intention is used to represent a real intention of an answer in the sample input data;
determining a probability value of each target intention from the probability values of the sample intentions; and
determining, among target intentions, a target intention having a probability value less than a second threshold as the first intention.

11. The computing system according to claim 10, wherein a label of a target intention is a first label, and a label of an intention that is not the target intention in the sample intentions is a second label; and
the resetting the label of each first intention of the at least one first intention based on the label of the sample intention includes:
resetting the label of each first intention to be the second label.

12. The computing system according to claim 10, wherein a label of a target intention is a first label, and a label of an intention that is not the target intention in the sample intentions is a second label;
the resetting the label of each first intention of the at least one first intention based on the label of the sample intention includes:
copying sample intentions in the sample training data to obtain extended intentions, wherein each extended intention corresponds to a sample intention;
resetting a label of a sample intention corresponding to the first intention to be the second label; and
resetting a label of an extended intention corresponding to the first intention to be the first label; and
wherein the continuing to train the intention identification model by using the reset sample training data after the label of the first intention has been reset includes:
continuing to train the intention identification model by using, as the sample output data, the sample intentions and the extended intentions obtained after the label of the first intention has been reset.

13. The computing system of claim 8, wherein the acts further comprise:
performing intention identification on to-be-identified data by using an intention identification model trained through the M rounds of model training to obtain an intention identification result.

14. The computing system according to claim 13, wherein the to-be-identified data includes a to-be-identified set of a question and an answer; and
the performing the intention identification on the to-be-identified data by using the intention identification model trained through the M rounds of model training to obtain the intention identification result includes:
inputting the to-be-identified data to the intention identification model trained through the M rounds of model training to obtain a preliminary intention identification result output by the intention identification model;
in response to that the preliminary intention identification result is an extended intention, inputting the answer in the to-be-identified set to a pre-trained question prediction model to obtain a predicted question, wherein the question prediction model is obtained by training at least one sample set, and each sample set includes one question and one answer;
determining whether the question in the to-be-identified set is consistent with the predicted question;
in response to that the question in the to-be-identified set is consistent with the predicted question, determining that the preliminary intention identification result is an intention identification result of the to-be-identified data; and
in response to that the question in the to-be-identified set is inconsistent with the predicted question, determining that the preliminary intention identification result is not an intention identification result of the to-be-identified data.

15. A storage medium having computer executable instructions stored thereon, the computer executable instructions, when executed by the one or more processors, enabling the one or more processors to, individually or collectively, perform acts comprising:
obtaining sample training data, the sample training data including sets of questions and answers configured to be sample input data and sample intentions configured to be sample output data, the questions including a target question, and the target question satisfying that an intention corresponding to an answer to the target question is a same as an intention corresponding to an answer to another question;
weakening training of an intention identification model with respect to the target question in first N rounds of model training in performing M rounds of model training by using the sample training data, so that a probability that the intention identification model obtained through the first N rounds of training identifies an intention corresponding to an answer to the target question is less than a first threshold, both M and N being positive integers, and N<M;
performing intention identification on the sample input data by using the intention identification model obtained through the first N rounds of model training to obtain at least one first intention;
resetting a label of each first intention of the at least one first intention based on a label of a sample intention to obtain reset sample training data; and
continuing to train the intention identification model by using the reset sample training data after the label of the first intention has been reset.

16. The storage medium according to claim 15, wherein the sample training data includes first sample training data, and questions in the first sample training data do not include the target question; and
the weakening the training of the intention identification model with respect to the target question in the first N rounds of model training includes:
training the intention identification model in the first N rounds of model training by using the first sample training data.

17. The storage medium according to claim 15, wherein the performing the intention identification on the sample input data by using the intention identification model obtained through the first N rounds of model training to obtain the at least one first intention includes:
inputting the sample input data to the intention identification model obtained through the first N rounds of model training, to output probability values of sample intentions;
determining, from the sample intentions, a target intention corresponding to each piece of sample input data that is input to the intention identification model, wherein the target intention is used to represent a real intention of an answer in the sample input data;
determining a probability value of each target intention from the probability values of the sample intentions; and
determining, among target intentions, a target intention having a probability value less than a second threshold as the first intention.

18. The storage medium according to claim 17, wherein a label of a target intention is a first label, and a label of an intention that is not the target intention in the sample intentions is a second label; and
the resetting the label of each first intention of the at least one first intention based on the label of the sample intention includes:
resetting the label of each first intention to be the second label.

19. The storage medium according to claim 17, wherein a label of a target intention is a first label, and a label of an intention that is not the target intention in the sample intentions is a second label;
the resetting the label of each first intention of the at least one first intention based on the label of the sample intention includes:
copying sample intentions in the sample training data to obtain extended intentions, wherein each extended intention corresponds to a sample intention;
resetting a label of a sample intention corresponding to the first intention to be the second label; and
resetting a label of an extended intention corresponding to the first intention to be the first label; and
wherein the continuing to train the intention identification model by using the reset sample training data after the label of the first intention has been reset includes:
continuing to train the intention identification model by using, as the sample output data, the sample intentions and the extended intentions obtained after the label of the first intention has been reset.

20. The storage medium of claim 15, wherein the acts further comprise:
performing intention identification on to-be-identified data by using an intention identification model trained through the M rounds of model training to obtain an intention identification result,
wherein:
the to-be-identified data includes a to-be-identified set of a question and an answer; and
the performing the intention identification on the to-be-identified data by using the intention identification model trained through the M rounds of model training to obtain the intention identification result includes:
inputting the to-be-identified data to the intention identification model trained through the M rounds of model training to obtain a preliminary intention identification result output by the intention identification model;
in response to that the preliminary intention identification result is an extended intention, inputting the answer in the to-be-identified set to a pre-trained question prediction model to obtain a predicted question, wherein the question prediction model is obtained by training at least one sample set, and each sample set includes one question and one answer;
determining whether the question in the to-be-identified set is consistent with the predicted question;
in response to that the question in the to-be-identified set is consistent with the predicted question, determining that the preliminary intention identification result is an intention identification result of the to-be-identified data; and
in response to that the question in the to-be-identified set is inconsistent with the predicted question, determining that the preliminary intention identification result is not an intention identification result of the to-be-identified data.
